(19) United States
(12) Patent Application Publication
(10) Pub. No.: US 2006/0285258 A1
(43) Pub. Date: Dec. 21, 2006

(54) MAGNETIC SENSING ELEMENT INCLUDING FREE LAYER CONTAINING HALF-METAL

(76) Inventors: Kazumasa Nishimura, Niigata-ken (JP); Masamichi Saito, Niigata-ken (JP); Yosuke Ide, Niigata-ken (JP); Masahiko Ishizone, Niigata-ken (JP); Naoya Hasegawa, Niigata-ken (JP)

Correspondence Address: BRINKS HOFER GILSON & LIONE, P.O. BOX 10395, CHICAGO, IL, 60610, US

(21) Appl. No.: 11/421,727

(22) Filed: Jun. 1, 2006

(30) Foreign Application Priority Data
Jun. 17, 2005 (JP) 2005-177606

(51) Int. Cl. G11B 5/127; G11B 5/33

(52) U.S. Cl. 360/324.1; 360/324.12

(57) ABSTRACT

A magnetic sensing element includes a multilayer film including a pinned magnetic layer in which the magnetization direction is pinned in one direction, a free magnetic layer, and a nonmagnetic layer provided between the pinned magnetic layer and the free magnetic layer. In the magnetic sensing element, at least one of the pinned magnetic layer and the free magnetic layer includes a half-metallic alloy layer and a CoₓFe₁₀₀₋ₓ layer is provided between the half-metallic alloy layer and the nonmagnetic layer.

### BACKGROUND

1. Field

A current perpendicular to the plane (CPP) magnetic sensing element in which the sense current flows in a direction perpendicular to the surface of a film is provided. More specifically, a magnetic sensing element in which the product ΔRA of an amount of change in resistance and an element area that can be increased and a ferromagnetic coupling magnetic field Hᵢₙ generated by the magnetostatic coupling (topological coupling) between a free magnetic layer and a pinned magnetic layer can be decreased is provided.

2. Related Art

FIG. 11 is a partial cross-sectional view of a known magnetic sensing element (spin-valve thin film element) cut from the direction parallel to the surface facing a recording medium.

Referring to FIG. 11, a base layer 1 is composed of Ta, and a seed layer 2 composed of a metal having a body-centered cubic (bcc) structure, for example Cr, is provided on the base layer 1.

A multilayer film T prepared by sequentially laminating an antiferromagnetic layer 3, a pinned magnetic layer 4, a nonmagnetic layer 5, a free magnetic layer 6, and a protective layer 7 is provided on the seed layer 2.

The protective layer 7 is composed of Ta, the nonmagnetic layer 5 is composed of Cu, the free magnetic layer 6 and the pinned magnetic layer 4 are composed of a Heusler alloy such as a Co₂MnGe alloy, and the antiferromagnetic layer 3 is composed of PtMn.

Electrode layers 10 are provided on and under the multilayer film T, and a direct sense current flows in the direction perpendicular to the surface of each layer of the multilayer film T.

An exchange coupling magnetic field is generated at the interface between the antiferromagnetic layer 3 and the pinned magnetic layer 4, thereby pinning the magnetization of the pinned magnetic layer 4 in the height direction (in the Y direction in the figure).

Hard bias layers 8 composed of a hard magnetic material such as CoPt are provided at each end of the free magnetic layer 6. The upper parts, the lower parts, and the ends of the hard bias layers 8 are insulated by insulating layers 9. The magnetization of the free magnetic layer 6 is aligned in the track width direction (in the X direction in the figure) by a longitudinal bias magnetic field from the hard bias layers 8.

When an external magnetic field is applied to the magnetic sensing element shown in FIG. 11, the magnetization direction of the free magnetic layer 6 is changed relative to that of the pinned magnetic layer 4. Consequently, the resistance of the multilayer film T is changed. Under a constant sense current, such a change in resistance is detected as a change in voltage, thereby enabling detection of the external magnetic field.

Japanese Unexamined Patent Application Publication No. 2003-218428 discloses a magnetic sensing element including a free magnetic layer composed of a Heusler alloy.

According to the description of Japanese Unexamined Patent Application Publication No. 2003-218428, a free magnetic layer is composed of a Heusler alloy such as a CoMnGe alloy. A pinned magnetic layer is also composed of a Heusler alloy such as a CoMnGe alloy.

In order to achieve an excellent performance as a magnetic sensing element, preferably, the product ΔRA of an amount of change in magnetoresistance and an element area is increased and a ferromagnetic coupling magnetic field Hᵢₙ generated by the magnetostatic coupling (topological coupling) between the free magnetic layer 6 and the pinned magnetic layer 4 is decreased.

However, is has become clear that a large ΔRA and a small Hᵢₙ cannot be achieved at the same time only by forming the free magnetic layer and the pinned magnetic layer using a Heusler alloy, and thus a magnetic sensing element with desirable magnetic properties cannot be achieved.

### SUMMARY

A magnetic sensing element in which the product ΔRA of an amount of change in resistance ΔR and an element area A can be increased and a ferromagnetic coupling magnetic field Hᵢₙ generated by the magnetostatic coupling (topological coupling) between the free magnetic layer and the pinned magnetic layer can be decreased is provided.

Provided is a magnetic sensing element including a multilayer film including a pinned magnetic layer in which the magnetization direction is pinned in one direction; a free magnetic layer; and a nonmagnetic layer provided between the pinned magnetic layer and the free magnetic layer. A current flows in a direction perpendicular to the surfaces of the layers in the multilayer film. At least one of the pinned magnetic layer and the free magnetic layer includes a half-metallic alloy layer. A CoₓFe₁₀₀₋ₓ layer (wherein X represents a composition ratio and satisfies 0≦X≦100) is provided between the half-metallic alloy layer and the nonmagnetic layer.

In the magnetic sensing element, the half-metallic alloy layer may be composed of a Heusler alloy represented by a composition ratio of X₂YZ where X is an element selected from Group IIIA to Group IIB in the periodic table, Y is Mn, and Z is at least one element selected from Al, Si, Ga, Ge, In, Sn, Tl, Pb, and Sb or a Heusler alloy represented by a composition ratio of XYZ where X is an element selected from Group IIIA to Group IIB in the periodic table, Y is Mn, and Z is at least one element selected from Al, Si, Ga, Ge, In, Sn, Tl, Pb, and Sb.

The nonmagnetic layer may be composed of at least one element selected from Cu, Au, and Ag.

Preferably, the half-metallic alloy layer is composed of a Co₂MnGe alloy, the nonmagnetic layer is composed of Cu, the thickness of the Cu layer constituting the nonmagnetic layer is in the range of 18 to 50 Å, and the composition ratio of Ge in the Co₂MnGe alloy constituting the half-metallic alloy layer is in the range of 20 to 27 atomic percent. More preferably, the composition ratio of Ge in the Co₂MnGe alloy constituting the half-metallic alloy layer is in the range of 21 to 26 atomic percent.

Preferably, the half-metallic alloy layer is composed of a Co₂MnGe alloy, the nonmagnetic layer is composed of Cu, the thickness of the Cu layer constituting the nonmagnetic layer is in the range of 18 to 60 Å, and the composition ratio of Ge in the Co₂MnGe alloy constituting the half-metallic alloy layer is in the range of 24 to 27 atomic percent. More preferably, the composition ratio of Ge in the Co₂MnGe alloy constituting the half-metallic alloy layer is in the range of 24 to 26 atomic percent.

In the magnetic sensing element, the pinned magnetic layer may be provided above the free magnetic layer. Alternatively, the pinned magnetic layer may be provided below the free magnetic layer. Alternatively, the nonmagnetic layer and the pinned magnetic layer may be provided below the free magnetic layer and another nonmagnetic layer and another pinned magnetic layer may be provided above the free magnetic layer.

At least one of the pinned magnetic layer and the free magnetic layer includes a half-metallic alloy layer. A CoₓFe₁₀₀₋ₓ layer (wherein X represents a composition ratio and satisfies 0≦X≦100) is provided between the half-metallic alloy layer and a nonmagnetic layer.

Since the CoₓFe₁₀₀₋ₓ layer (wherein X represents a composition ratio and satisfies 0≦X≦100) is provided between the half-metallic alloy layer and a nonmagnetic layer as described above, the product ΔRA of an amount of change in resistance ΔR and an element area A can be increased and a ferromagnetic coupling magnetic field Hᵢₙ generated by the magnetostatic coupling (topological coupling) between the free magnetic layer and the pinned magnetic layer can be decreased.

### BRIEF DESCRIPTION OF THE DRAWINGS

FIG. 1 is a cross-sectional view of the structure of a magnetic sensing element (single spin-valve magnetoresistive element) according to a first embodiment, viewed from a surface facing a recording medium;

FIG. 2 is a cross-sectional view of the structure of a magnetic sensing element (dual spin-valve magnetoresistive element) according to a second embodiment, viewed from a surface facing a recording medium;

FIG. 3 is a cross-sectional view of the structure of a magnetic sensing element (single spin-valve magnetoresistive element) according to a third embodiment, viewed from a surface facing a recording medium;

FIG. 4 is a graph showing the relationship between the composition ratio of Ge in Co₂MnGe and the product ΔRA of an amount of change in resistance ΔR and an element area A in an example;

FIG. 5 is a graph showing the relationship between the thickness of a copper (Cu) layer constituting a nonmagnetic layer and a ferromagnetic coupling magnetic field Hᵢₙ between a free magnetic layer and a pinned magnetic layer in an example and a comparative example;

FIG. 6 is a graph showing the relationship between the thickness of a Cu layer constituting a nonmagnetic layer and a ferromagnetic coupling magnetic field Hᵢₙ between a free magnetic layer and a pinned magnetic layer in an example and a comparative example;

FIG. 7 is a graph showing the relationship between the thickness of a Cu layer constituting a nonmagnetic layer and a ferromagnetic coupling magnetic field Hᵢₙ between a free magnetic layer and a pinned magnetic layer in an example and a comparative example;

FIG. 8 is a graph showing the relationship between the thickness of a Cu layer constituting a nonmagnetic layer and a ferromagnetic coupling magnetic field Hᵢₙ between a free magnetic layer and a pinned magnetic layer in an example and a comparative example;

FIG. 9 is a graph showing the relationship between the thickness of a Cu layer constituting a nonmagnetic layer and a ferromagnetic coupling magnetic field Hᵢₙ between a free magnetic layer and a pinned magnetic layer in an example;

FIG. 10 is a graph showing preferable ranges of the thickness of a Cu layer constituting a nonmagnetic layer and the composition ratio of Ge in Co₂MnGe constituting a pinned magnetic layer and a free magnetic layer; and

FIG. 11 is a cross-sectional view of the structure of a known magnetic sensing element, viewed from a surface facing a recording medium.

### DESCRIPTION

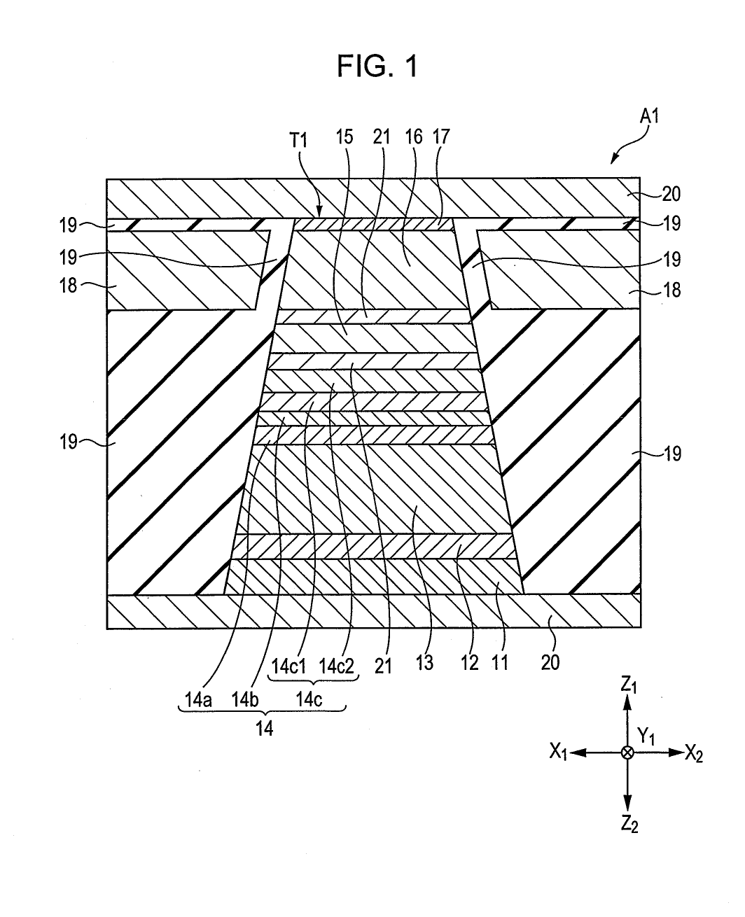

FIG. 1 is a cross-sectional view of the overall structure of a magnetic sensing element (single spin-valve magnetoresistive element) according to a first embodiment, viewed from a surface facing a recording medium. FIG. 1 shows only the central part of the element extending in the X direction.

A magnetic sensing element Al shown in FIG. 1 is mounted, for example, at the trailing edge of a floating slider installed in a hard disk device to detect magnetic fields of portions corresponding to information recorded on a hard disk. A magnetic recording medium such as a hard disk moves in the Z direction, and the direction of the leakage magnetic field from the magnetic recording medium is in the Y direction.

Referring to FIG. 1, a base layer 11 composed of a nonmagnetic material, for example, at least one element selected from Ta, Hf, Nb, Zr, Ti, Mo, and W is provided at the bottom. A multilayer film Tl is provided on the base layer 11. The multilayer film Tl includes a seed layer 12, an antiferromagnetic layer 13, a pinned magnetic layer 14, a CoₓFe₁₀₀₋ₓ layer (wherein X represents a composition ratio and satisfies 0≦X≦100) 21, a nonmagnetic layer 15, another CoₓFe₁₀₀₋ₓ layer (wherein X represents a composition ratio and satisfies 0≦X≦100) 21, a free magnetic layer 16, and a protective layer 17. The magnetic sensing element A1 shown in FIG. 1 is a bottom spin-valve giant magnetoresistive (GMR) magnetic sensing element in which the antiferromagnetic layer 13 is provided under the free magnetic layer 16.

The seed layer 12 is composed of a NiFeCr alloy or Cr. When the seed layer 12 is composed of a NiFeCr alloy, the seed layer 12 has the face-centered cubic (fcc) structure, in which equivalent crystal planes represented as {111} planes are preferentially oriented in the direction parallel to the layer surface. When the seed layer 12 is composed of Cr, the seed layer 12 has a body-centered cubic (bcc) structure, in which equivalent crystal planes represented as {110} planes are preferentially oriented in the direction parallel to the layer surface.

The base layer 11 substantially has an amorphous structure. The formation of this base layer 11 is not essential.

The antiferromagnetic layer 13 provided on the seed layer 12 is preferably composed of an antiferromagnetic material containing X and Mn, wherein X is at least one element selected from Pt, Pd, Ir, Rh, Ru, and Os.

The antiferromagnetic layer 13 has the face-centered cubic (fcc) structure or the face-centered tetragonal (fct) structure.

These X-Mn alloys containing an element of the platinum group are excellent as antiferromagnetic materials because they have superior corrosion resistance and high blocking temperatures and can generate large exchange coupling magnetic fields (Hₑₓ). For example, a binary PtMn alloy or IrMn alloy can be used.

According to the present invention, the antiferromagnetic layer 13 may be composed of an antiferromagnetic material containing X, X′, and Mn, wherein X′ is at least one element selected from Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, and rare earth elements.

The following element or elements are preferably used as X′: An element or elements that enter the interstices in the space lattice formed by X and Mn to form an interstitial solid solution. Alternatively, the element or elements partially replace lattice points of the crystal lattice formed by X and Mn to form a substitutional solid solution. Herein, the term “solid solution” refers to a solid whose components are homogeneously mixed over wide ranges.

The X′ content is preferably in the range of 0.2 to 10 atomic percent, and more preferably, in the range of 0.5 to 5 atomic percent. The element represented by X is preferably Pt or Ir.

The X content or the X+X′ content in the antiferromagnetic layer 13 is preferably in the range of 45 to 60 atomic percent, and more preferably, in the range of 49 to 56.5 atomic percent. In this case, the interface with the pinned magnetic layer 14 is formed into the mismatched state during deposition, and the antiferromagnetic layer 13 can achieve an adequate order transformation by being annealed.

In the embodiment shown in FIG. 1, the pinned magnetic layer 14 is formed by sequentially depositing a first magnetic sublayer 14a, a nonmagnetic interlayer 14b, and a second magnetic sublayer 14c from the bottom (from the side of Z2 direction shown in the figure). As shown in FIG. 1, the second magnetic sublayer 14c is composed of a first ferromagnetic sublayer 14c1 and a second ferromagnetic sublayer 14c2 being ferromagnetic.

The first magnetic sublayer 14a is magnetized in the direction antiparallel to the magnetization direction of the second magnetic sublayer 14c by the exchange coupling magnetic field generated at the interface with the antiferromagnetic layer 13 and by the antiferromagnetic exchange coupling magnetic field (Ruderman-Kittel-Kasuya-Yoshida interaction, i.e., RKKY interaction) through the nonmagnetic interlayer 14b. This antiparallel state, which is known as a synthetic ferrimagnetic coupling state, can stabilize the magnetization of the pinned magnetic layer 14 and increase the apparent exchange coupling magnetic field generated at the interface between the pinned magnetic layer 14 and the antiferromagnetic layer 13.

In the pinned magnetic layer 14, the second magnetic sublayer 14c includes the second ferromagnetic sublayer 14c2. Thus, when the pinned magnetic layer 14 includes the second ferromagnetic sublayer 14c2, the amount of change in resistance ΔR and a ratio of change in resistance ΔR/R can be improved.

However, the pinned magnetic layer 14 may be formed as a single layer composed of a magnetic layer or as a multilayer composed of magnetic sublayers.

The first magnetic sublayer 14a and the first ferromagnetic sublayer 14c1 can be composed of a ferromagnetic material such as a CoFe alloy, a NiFe alloy, or Co.

The nonmagnetic interlayer 14b is composed of a nonmagnetic conductive material such as Ru, Rh, Ir, Cr, Re, or Cu.

The second ferromagnetic sublayer 14c2 constituting the pinned magnetic layer 14 can be composed of any of the following materials (1) and (2).

(1) A Heusler alloy represented by a composition ratio of X₂YZ wherein X is an element selected from Group IIIA to Group IIB in the periodic table, Y is Mn, and Z is at least one element selected from Al, Si, Ga, Ge, In, Sn, Tl, Pb, and Sb.

(2) A Heusler alloy represented by a composition ratio of XYZ wherein X is an element selected from Group IIIA to Group IIB in the periodic table, Y is Mn, and Z is at least one element selected from Al, Si, Ga, Ge, In, Sn, Tl, Pb, and Sb.

The Heusler alloys described in (1) and (2) above are ferromagnetic and have a half-metallic property. These Heusler alloys are useful materials for increasing the product ΔRA of an amount of change in resistance ΔR and an element area A of a CPP-GMR magnetic sensing element.

The nonmagnetic layer 15 provided on the pinned magnetic layer 14 is composed of at least one element selected from Cu, Au, and Ag.

Furthermore, a free magnetic layer 16 is provided. The free magnetic layer 16 can also be composed of a half-metallic alloy layer, and can be composed of any of the Heusler alloys described in (1) and (2) above.

In order to improve the crystallinity and the regularity, each of the second ferromagnetic sublayer 14c2 and the free magnetic layer 16 preferably has a thickness of 40 to 80 Å.

In the embodiment shown in FIG. 1, hard bias layers 18 are provided at each end of the free magnetic layer 16. The magnetization of the free magnetic layer 16 is aligned in the track width direction (in the X direction in the figure) by a longitudinal bias magnetic field from the hard bias layers 18. The hard bias layers 18 are composed of a cobalt-platinum (Co—Pt) alloy, a cobalt-chromium-platinum (Co—Cr—Pt) alloy, or the like.

The upper parts, the lower parts, and the ends of the hard bias layers 18 are insulated by insulating layers 19 composed of alumina or the like.

Electrode layers 20 are provided on and under the multilayer film T1. The magnetic sensing element of this embodiment is a CPP-GMR magnetic sensing element in which a sense current flows in the direction perpendicular to the surface of each layer of the multilayer film T1.

The electrode layers 20 are composed of α-Ta, Au, Cr, Cu, Rh, Ir, Ru, W, or the like.

In preparation of the magnetic sensing element Al shown in FIG. 1, the layers are sequentially deposited from the base layer 11 up to the protective layer 17, and the layers are then annealed so as to generate the exchange coupling magnetic field at the interface between the antiferromagnetic layer 13 and the pinned magnetic layer 14. During annealing, magnetization of the pinned magnetic layer 14 is pinned in the Y direction in the figure by the application of a magnetic field in the Y direction. In the embodiment shown in FIG. 1, the pinned magnetic layer 14 has a synthetic ferrimagnetic structure. Therefore, for example, when the first magnetic sublayer 14a is magnetized in the Y direction in the figure, the second magnetic sublayer 14c, which is composed of the first ferromagnetic sublayer 14c1 and a second ferromagnetic sublayer 14c2 is magnetized in the direction opposite to the Y direction. In addition, the free magnetic layer 16 forms a superlattice by being annealed.

In the magnetic sensing element A1 shown in FIG. 1, the magnetization direction of the pinned magnetic layer 14 is orthogonal to that of the free magnetic layer 16. A leakage magnetic field from a recording medium enters the magnetic sensing element in the Y direction in the figure. The magnetization of the free magnetic layer 16 is sensitively changed in response to the magnetic field. The electrical resistance is changed according to the relationship between the above change in the magnetization direction and the pinned magnetization direction of the pinned magnetic layer 14. The leakage magnetic field from the recording medium is detected by changes in voltage or current based on the change in the electrical resistance.

As described above, the second ferromagnetic sublayer 14c2 and the free magnetic layer 16 are composed of a Heusler alloy, which is a half-metallic alloy layer. The term “Heusler alloy” is a generic term for metallic compounds having a Heusler crystal structure. Heusler alloys show ferromagnetism depending on their composition. Heusler alloys are metals having a large spin-polarizability and have a half-metallic property in which most of the conduction electrons are composed of either only spin-up electrons or only spin-down electrons.

The use of a Heusler alloy as the materials of the pinned magnetic layer 14 and the free magnetic layer 16 of the CPP-GMR magnetic sensing element has the following advantage: The use of a Heusler alloy increases the change in spin diffusion length or the change in mean free path of the conduction electrons in the pinned magnetic layer 14 and the free magnetic layer 16, the change being caused by the application of an external magnetic field. In other words, the change in the resistance of the multilayer film can be increased. As a result, the product ΔRA of an amount of change in resistance ΔR and an element area A can be increased, thereby improving the sensitivity of detecting the external magnetic field.

When the second ferromagnetic sublayer 14c2 and the free magnetic layer 16 that are composed of a Heusler alloy layer described in (1) or (2) above are provided so as to be in contact with the nonmagnetic layer 15, the ferromagnetic coupling magnetic field Hᵢₙ generated by the magnetostatic coupling (topological coupling) between the pinned magnetic layer 14 and the free magnetic layer 16 is increased, resulting in a problem of decreasing the sensitivity of detecting the external magnetic field.

In the magnetic sensing element A1 shown in FIG. 1, which has the following characteristic structure, the improvement in the ΔRA and the decrease in the Hᵢₙ can be achieved at the same time. The characteristic part of the magnetic sensing element A1 shown in FIG. 1 will now be described.

In the magnetic sensing element A1 shown in FIG. 1, the CoₓFe₁₀₀₋ₓ layer 21 is provided between the second ferromagnetic sublayer 14c2 constituting the pinned magnetic layer 14 and the nonmagnetic layer 15. In addition, the other CoₓFe₁₀₀₋ₓ layer 21 is provided between the free magnetic layer 16 composed of a half-metallic alloy and the nonmagnetic layer 15. That is, in the magnetic sensing element A1 shown in FIG. 1, the CoₓFe₁₀₀₋ₓ layers 21 are provided between the second ferromagnetic sublayer 14c2 and the nonmagnetic layer 15 and between the free magnetic layer 16 and the nonmagnetic layer 15, the layers 14c2 and 16 being composed of a half-metallic alloy.

Thus, when the CoₓFe₁₀₀₋ₓ layers 21 are provided between the second ferromagnetic sublayer 14c2 and the nonmagnetic layer 15 and between the free magnetic layer 16 and the nonmagnetic layer 15, the layers 14c2 and 16 being composed of a half-metallic alloy, the product ΔRA of an amount of change in resistance ΔR and an element area A can be increased and the ferromagnetic coupling magnetic field Hᵢₙ generated by the magnetostatic coupling (topological coupling) between the free magnetic layer and the pinned magnetic layer can be decreased.

The thickness of the CoₓFe₁₀₀₋ₓ layers 21 is preferably in the range of 1 to 5 Å. When the thickness is 1 Å or less, undesirably, the effect of decreasing the ferromagnetic coupling magnetic field Hᵢₙ is decreased. When the thickness exceeds 5 Å, undesirably, the product ΔRA of an amount of change in resistance and an element area is decreased.

For example, when the nonmagnetic layer 15 is composed of Cu and the second ferromagnetic sublayer 14c2 and the free magnetic layer 16 are composed of a Co₂MnGe alloy, preferred ranges of Ge composition of the Co₂MnGe alloy constituting the second ferromagnetic sublayer 14c2 and the free magnetic layer 16, and preferred ranges of the thickness of the nonmagnetic layer 15 include the following.

As a first range, the thickness of the copper (Cu) layer constituting the nonmagnetic layer 15 is 18 to 50 Å and the composition ratio of Ge in the Co₂MnGe alloy constituting the second ferromagnetic sublayer 14c2 or the free magnetic layer 16 is 20 to 27 atomic percent, in other words, the composition ratio is represented by (Co₂Mn)₁₀₀₋ₐGeₐ wherein a=20 to 27.

As a second range, the thickness of the Cu layer constituting the nonmagnetic layer 15 is 18 to 60 Å and the composition ratio of Ge in the Co₂MnGe alloy constituting the second ferromagnetic sublayer 14c2 or the free magnetic layer 16 is 24 to 27 atomic percent, in other words, the composition ratio is represented by (Co₂Mn)₁₀₀₋ₐGeₐ wherein a=24 to 27.

As described below, when the thickness of the Cu layer and the composition ratio of Ge are within the above ranges, the product ΔRA of an amount of change in resistance ΔR and an element area A can be increased and the ferromagnetic coupling magnetic field Hᵢₙ generated by the magnetostatic coupling (topological coupling) between the free magnetic layer 16 and the pinned magnetic layer 14 can be decreased.

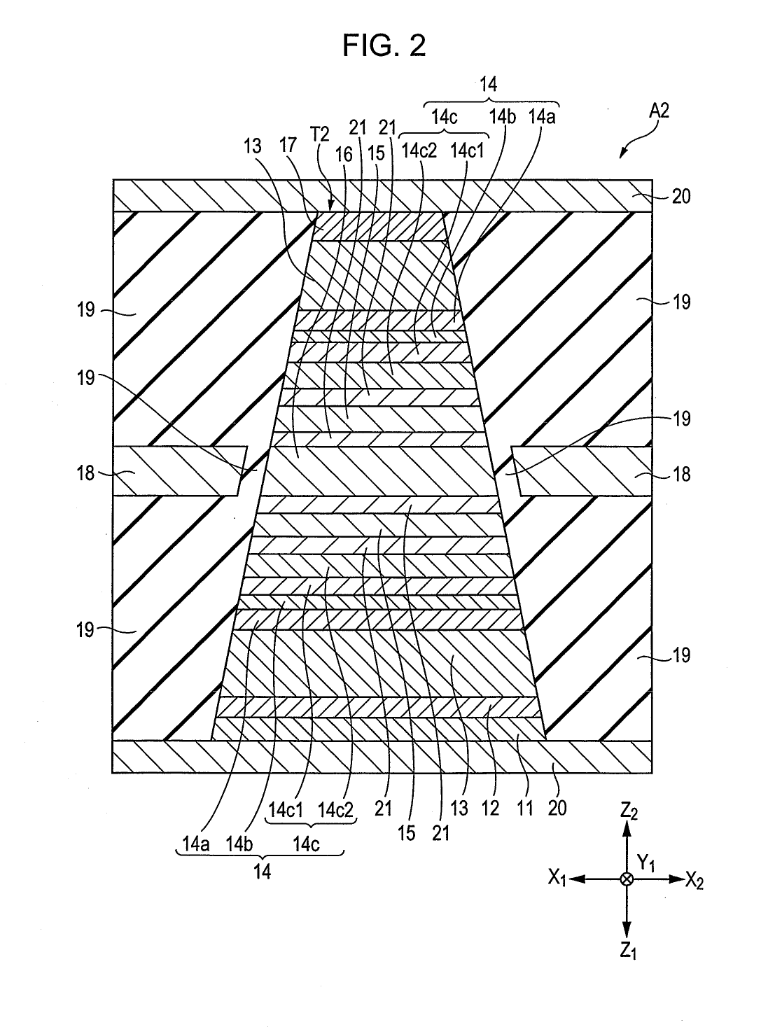

FIG. 2 is a partial cross-sectional view showing the structure of a magnetic sensing element (dual spin-valve magnetoresistive element) according to a second embodiment. In a magnetic sensing element A2 shown in FIG. 2, the same parts as those of the magnetic sensing element A1 shown in FIG. 1 have the same reference numerals and the details thereof are not described.

In the magnetic sensing element A2 shown in FIG. 2, from the bottom, a base layer 11, a seed layer 12, an antiferromagnetic layer 13, a pinned magnetic layer 14, a CoₓFe₁₀₀₋ₓ layer 21, a nonmagnetic layer 15, another Coₓ_{Fe}₁₀₀₋ₓ layer 21, and a free magnetic layer 16 are sequentially deposited. Furthermore, on the free magnetic layer 16, another CoₓFe₁₀₀₋ₓ layer 21, another nonmagnetic layer 15, another CoₓFe₁₀₀₋ₓ layer 21, another pinned magnetic layer 14, another antiferromagnetic layer 13, and a protective layer 17 are sequentially deposited to form a multilayer film T2.

Hard bias layers 18 are provided at each end of the free magnetic layer 16. The hard bias layers 18 are insulated by insulating layers 19 composed of alumina or the like.

Electrode layers 20 are provided on and under the multilayer film T2. The magnetic sensing element of this embodiment is a CPP-GMR magnetic sensing element in which a sense current flows in the direction perpendicular to the surface of each layer of the multilayer film T2.

The pinned magnetic layers 14 of the magnetic sensing element A2 shown in FIG. 2 are also formed by sequentially depositing a first magnetic sublayer 14a, a nonmagnetic interlayer 14b, and a second magnetic sublayer 14c. As shown in FIG. 2, each of the second magnetic sublayers 14c is composed of a first ferromagnetic sublayer 14c1 and a second ferromagnetic sublayer 14c2 being ferromagnetic.

The second ferromagnetic sublayers 14c2 constituting the pinned magnetic layers 14 can be composed of any of the above-described materials (1) and (2).

The free magnetic layer 16 can also be composed of a half-metallic alloy and can be composed of any of the Heusler alloys described in (1) and (2).

In the magnetic sensing element A2 shown in FIG. 2, the magnetization direction of the pinned magnetic layers 14 is orthogonal to that of the free magnetic layer 16. A leakage magnetic field from a recording medium enters the magnetic sensing element in the Y direction in the figure. The magnetization of the free magnetic layer 16 is sensitively changed in response to the magnetic field. The electrical resistance is changed according to the relationship between the above change in the magnetization direction and the pinned magnetization direction of the pinned magnetic layers 14. The leakage magnetic field from the recording medium is detected on the basis of changes in voltage or current based on the change in the electrical resistance. In the dual spin-valve magnetic sensing element A2 shown in FIG. 2, two pinned magnetic layers 14 are provided on and under the free magnetic layer 16 with the nonmagnetic layers 15 therebetween. Therefore, the product ΔRA of an amount of change in resistance ΔR and an element area A of the magnetic sensing element A2 can be theoretically double the product ΔRA of the single spin-valve magnetic sensing element A1 shown in FIG. 1.

In the magnetic sensing element A2 shown in FIG. 2, the CoₓFe₁₀₀₋ₓ layer 21 is provided between the second ferromagnetic sublayer 14c2 constituting the pinned magnetic layer 14 and the nonmagnetic layer 15. In addition, the other CoₓFe₁₀₀₋ₓ layer 21 is provided between the free magnetic layer 16 composed of a half-metallic alloy and the nonmagnetic layer 15. That is, in the magnetic sensing element A2 shown in FIG. 2, the CoₓFe₁₀₀₋ₓ layers 21 are provided between each of the second ferromagnetic sublayers 14c2 and the corresponding nonmagnetic layer 15 and between the free magnetic layer 16 and each of the nonmagnetic layers 15, the layers 14c2 and 16 being composed of a half-metallic alloy.

Thus, when each of the CoₓFe₁₀₀₋ₓ layers 21 is provided between the corresponding second ferromagnetic sublayer 14c2 and the corresponding nonmagnetic layer 15 and between the free magnetic layer 16 and the corresponding nonmagnetic layer 15, the layers 14c2 and 16 being composed of a half-metallic alloy, the product ΔRA of an amount of change in resistance ΔR and an element area A can be increased and the ferromagnetic coupling magnetic field Hᵢₙ generated by the magnetostatic coupling (topological coupling) between the free magnetic layer and each of the pinned magnetic layers can be decreased.

For example, when the nonmagnetic layers 15 are composed of Cu and the second ferromagnetic sublayers 14c2 and the free magnetic layer 16 are composed of a Co₂MnGe alloy, preferred ranges of Ge composition of the Co₂MnGe alloy constituting each of the second ferromagnetic sublayers 14c2 and the free magnetic layer 16, and preferred ranges of the thickness of each of the nonmagnetic layers 15 include the following.

As a first range, the thickness of the Cu layer constituting each of the nonmagnetic layers 15 is 18 to 50 Å and the composition ratio of Ge in the Co₂MnGe alloy constituting each of the second ferromagnetic sublayers 14c2 or the free magnetic layer 16 is 20 to 27 atomic percent, in other words, the composition ratio is represented by (Co₂Mn)₁₀₀₋ₐGeₐ wherein a=20 to 27.

As a second range, the thickness of the Cu layer constituting each of the nonmagnetic layers 15 is 18 to 60 Å and the composition ratio of Ge in the Co₂MnGe alloy constituting each of the second ferromagnetic sublayers 14c2 or the free magnetic layer 16 is 24 to 27 atomic percent, in other words, the composition ratio is represented by (CO₂Mn)₁₀₀₋ₐGeₐ wherein a=24 to 27.

As described below, when the thickness of the Cu layer and the composition ratio of Ge are within the above ranges, the product ΔRA of an amount of change in resistance ΔR and an element area A can be increased and the ferromagnetic coupling magnetic field Hᵢₙ generated by the magnetostatic coupling (topological coupling) between the free magnetic layer 16 and each of the pinned magnetic layers 14 can be decreased.

Additionally, in the above first range, the composition ratio of Ge is more preferably in the range of 21 to 26 atomic percent because the product ΔRA can be increased to 8 (mΩμm²) or more.

Additionally, in the above second range, the composition ratio of Ge is more preferably in the range of 24 to 26 atomic percent because the product ΔRA can be increased to 8 (mΩμm²) or more.

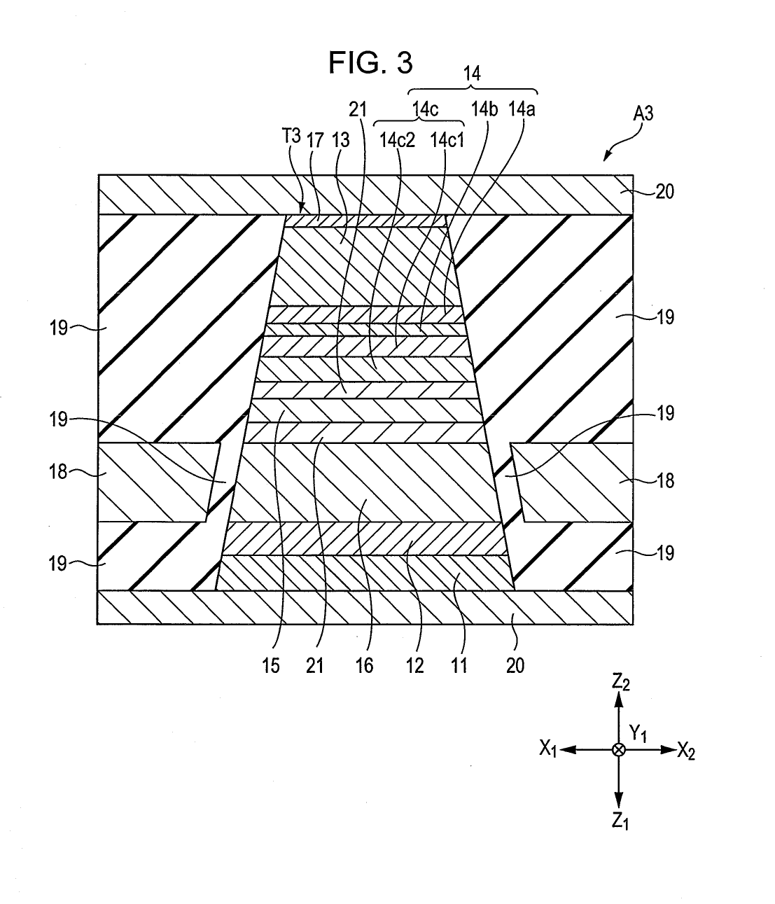

FIG. 3 is a partial cross-sectional view showing the structure of a magnetic sensing element (top spin-valve magnetic sensing element) according to a third embodiment. In a magnetic sensing element A3 shown in FIG. 3, the same parts as those of the magnetic sensing element A1 shown in FIG. 1 have the same reference numerals and the details thereof are not described.

In the magnetic sensing element A3 in FIG. 3, from the bottom, a base layer 11, a seed layer 12, a free magnetic layer 16, a CoₓFe₁₀₀₋ₓ layer 21, a nonmagnetic layer 15, another CoₓFe₁₀₀₋ₓ layer 21, a pinned magnetic layer 14, an antiferromagnetic layer 13, and a protective layer 17 are sequentially deposited to form a multilayer film T3.

Hard bias layers 18 are provided at each end of the free magnetic layer 16. The hard bias layers 18 are insulated by insulating layers 19 composed of alumina or the like.

Electrode layers 20 are provided on and under the multilayer film T3. The magnetic sensing element of this embodiment is a CPP-GMR magnetic sensing element in which a sense current flows in the direction perpendicular to the surface of each layer of the multilayer film T3.

The pinned magnetic layer 14 of the magnetic sensing element A3 in FIG. 3 is also formed by sequentially depositing a first magnetic sublayer 14a, a nonmagnetic interlayer 14b, and a second magnetic sublayer 14c from the bottom (from the side of Z2 direction shown in the figure). As shown in FIG. 3, the second magnetic sublayer 14c is composed of a first ferromagnetic sublayer 14c1 and a second ferromagnetic sublayer 14c2 being ferromagnetic.

The second ferromagnetic sublayer 14c2 constituting the pinned magnetic layer 14 can be composed of any of the above-described materials (1) and (2).

The free magnetic layer 16 can also be composed of a half-metallic alloy and can be composed of any of the Heusler alloys described in (1) and (2).

In the magnetic sensing element A3 shown in FIG. 3, the CoₓFe₁₀₀₋ₓ layer 21 is provided between the second ferromagnetic sublayer 14c2 constituting the pinned magnetic layer 14 and the nonmagnetic layer 15. In addition, the other CoₓFe₁₀₀₋ₓ layer 21 is provided between the free magnetic layer 16 composed of a half-metallic alloy and the nonmagnetic layer 15. That is, in the magnetic sensing element A3 shown in FIG. 3, the CoₓFe₁₀₀₋ₓ layers 21 are provided between the second ferromagnetic sublayer 14c2 and the nonmagnetic layer 15 and between the free magnetic layer 16 and the nonmagnetic layer 15, the layers 14c2 and 16 being composed of a half-metallic alloy.

Thus, when the CoₓFe₁₀₀₋ₓ layers 21 are provided between the second ferromagnetic sublayer 14c2 and the nonmagnetic layer 15 and between the free magnetic layer 16 and the nonmagnetic layer 15, the layers 14c2 and 16 being composed of a half-metallic alloy, the product ΔRA of an amount of change in resistance ΔR and an element area A can be increased and the ferromagnetic coupling magnetic field Hᵢₙ generated by the magnetostatic coupling (topological coupling) between the free magnetic layer and the pinned magnetic layer can be decreased.

For example, when the nonmagnetic layer 15 is composed of Cu and the second ferromagnetic sublayer 14c2 and the free magnetic layer 16 are composed of a Co₂MnGe alloy, preferred ranges of Ge composition of the Co₂MnGe alloy constituting the second ferromagnetic sublayer 14c2 and the free magnetic layer 16, and preferred ranges of the thickness of the nonmagnetic layer 15 include the following.

As a first range, the thickness of the Cu layer constituting the nonmagnetic layer 15 is 18 to 50 Å and the composition ratio of Ge in the Co₂MnGe alloy constituting the second ferromagnetic sublayer 14c2 or the free magnetic layer 16 is 20 to 27 atomic percent, in other words, the composition ratio is represented by (Co₂Mn)₁₀₀₋ₐGeₐ wherein a=20 to 27.

As a second range, the thickness of the Cu layer constituting the nonmagnetic layer 15 is 18 to 60 Å and the composition ratio of Ge in the Co₂MnGe alloy constituting the second ferromagnetic sublayer 14c2 or the free magnetic layer 16 is 24 to 27 atomic percent, in other words, the composition ratio is represented by (Co₂Mn)₁₀₀₋ₐGeₐ wherein a=24 to 27.

As described below, when the thickness of the Cu layer and the composition ratio of Ge are within the above ranges, the product ΔRA of an amount of change in resistance ΔR and an element area A can be increased and the ferromagnetic coupling magnetic field Hᵢₙ generated by the magnetostatic coupling (topological coupling) between the free magnetic layer 16 and the pinned magnetic layer 14 can be decreased.

In the description of the magnetic sensing elements Al to A3 of the embodiments shown in FIGS. 1 to 3, respectively, both the pinned magnetic layer 14 and the free magnetic layer 16 include a half-metallic alloy layer. However, the present invention is not limited thereto. It is sufficient that at least one of the pinned magnetic layer 14 and the free magnetic layer 16 includes the half-metallic alloy layer.

In the magnetic sensing elements A1 to A3 in FIGS. 1 to 3, respectively, the free magnetic layer 16 may have a laminated ferrimagnetic structure prepared by laminating two or more half-metallic alloy layers described in (1) or (2) above. Alternatively, the free magnetic layer 16 may have a laminated structure including the half-metallic alloy layer and another ferromagnetic layer.

In the above embodiments, the pinned magnetic layer 14 has a multilayered structure including the first magnetic sublayer 14a, a nonmagnetic interlayer 14b, and a second magnetic sublayer 14c, which is composed of the first ferromagnetic sublayer 14c1 and the second ferromagnetic sublayer 14c2 composed of a half-metallic alloy layer. Alternatively, the pinned magnetic layer 14 may have a single layer structure composed of the half-metallic alloy layer. Alternatively, the first magnetic sublayer 14a may be composed of a half-metallic alloy layer described in (1) or (2) above and the second magnetic sublayer 14c may be composed of a single layer of the second ferromagnetic sublayer 14c2.

In the description of the examples of the magnetic sensing elements A1 to A3 shown in FIGS. 1 to 3, respectively, the magnetization direction of the pinned magnetic layer 14 is pinned by the exchange coupling magnetic field generated at the interface with the antiferromagnetic layer 13. Alternatively, in the magnetic sensing elements A1 to A3, the pinned magnetic layer 14 may have a self-pinning structure in which the antiferromagnetic layer 13 does not overlap with the pinned magnetic layer 14 and the magnetization direction of the pinned magnetic layer 14 is pinned by means of a uniaxial anisotropy of the pinned magnetic layer 14 itself.

In the magnetic sensing elements A1 to A3 shown in FIGS. 1 to 3, respectively, the composition ratio of the CoₓFe₁₀₀₋ₓ layer 21 adjacent to the second ferromagnetic sublayer 14c2 constituting the pinned magnetic layer 14 and the composition ratio of the CoₓFe₁₀₀₋ₓ layer 21 adjacent to the free magnetic layer 16 may be the same or different.

### EXAMPLES

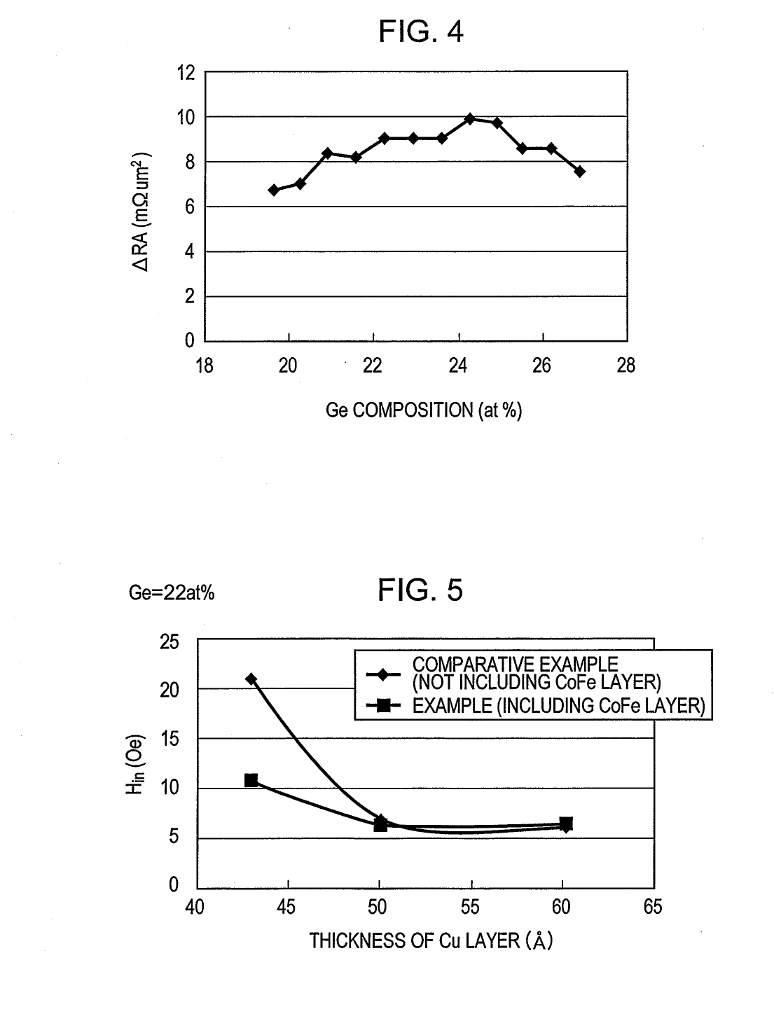

FIG. 4 is a graph showing the relationship between the composition ratio of Ge in a Co₂MnGe alloy and the product ΔRA of an amount of change in resistance ΔR and an element area A in a dual spin-valve magnetic sensing element having the structure of the magnetic sensing element A2 shown in FIG. 2. In this magnetic sensing element, each of the CoₓFe₁₀₀₋ₓ layers 21 adjacent to the corresponding second ferromagnetic sublayer 14c2 is composed of a Co₇₀Fe₃₀ layer and each of the CoₓFe₁₀₀₋ₓ layers 21 adjacent to the free magnetic layer 16 is composed of a Co₉₀Fe₁₀ layer. The second ferromagnetic sublayers 14c2 and the free magnetic layer 16 are composed of the Co₂MnGe alloy.

As shown in FIG. 4, when the composition ratio of Ge is 20 to 27 atomic percent, the value of ΔRA can be 7 (mΩμm²) or more.

In addition, as shown in FIG. 4, when the composition ratio of Ge is 21 to 26 atomic percent, the value of ΔRA can be 8 (mΩμm²) or more.

FIG. 5 is a graph showing the relationship between the thickness of a Cu layer constituting each nonmagnetic layer 15 and a ferromagnetic coupling magnetic field Hᵢₙ generated by the magnetostatic coupling (topological coupling) between the free magnetic layer 16 and the corresponding pinned magnetic layer 14 when a dual spin-valve magnetic sensing element having the structure of the magnetic sensing element A2 shown in FIG. 2 is produced and each of the nonmagnetic layers 15 is composed of Cu.

The graph shown in FIG. 5 shows measured values when the second ferromagnetic sublayers 14c2 and the free magnetic layer 16 are composed of a Co₂MnGe alloy and the composition ratio of Ge in the Co₂MnGe alloy is 22 atomic percent. In the graph, the curved line formed by joining the squares shows an example in which each of the CoₓFe₁₀₀₋ₓ layers 21 adjacent to the corresponding second ferromagnetic sublayer 14c2 is composed of a Co₇₀Fe₃₀ layer and each of the CoₓFe₁₀₀₋ₓ layers 21 adjacent to the free magnetic layer 16 is composed of a Co₉₀Fe₁₀ layer. The curved line formed by joining the rhombuses shows a comparative example in which the CoₓFe₁₀₀₋ₓ layers 21 are not provided.

As shown in FIG. 5, when the thickness of each Cu layer is 50 Å or less, the values of Hᵢₙ in the example is lower than those in the comparative example, and thus there is a difference in the value of Hᵢₙ between the example and the comparative example. However, when the thickness of the Cu layer exceeds 50 Å, there is no difference in the value of Hᵢₙ between the example and the comparative example. According to this result, in the case where the composition ratio of Ge is 22 atomic percent and the nonmagnetic layers 15 are composed of Cu, when the thickness of each Cu layer exceeds 50 Å, the value of Hᵢₙ cannot be decreased despite the formation of the Co₇₀Fe₃₀ layers or the Co₉₀Fe₁₀ layers. Thus, the effect of forming the Co₇₀Fe₃₀ layers or the Co₉₀Fe₁₀ layers is not achieved.

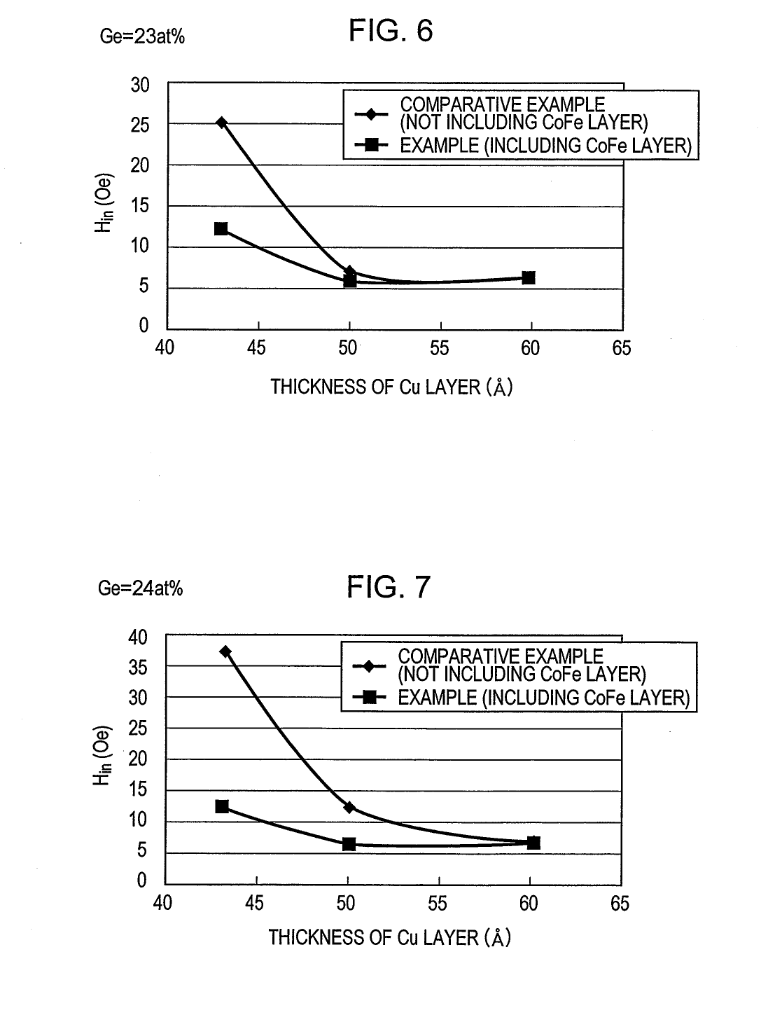

FIG. 6 is a graph showing the relationship between the thickness of a Cu layer constituting each nonmagnetic layer 15 and a ferromagnetic coupling magnetic field Hᵢₙ generated by the magnetostatic coupling (topological coupling) between the free magnetic layer 16 and the corresponding pinned magnetic layer 14 when a dual spin-valve magnetic sensing element having the structure of the magnetic sensing element A2 shown in FIG. 2 is produced and each of the nonmagnetic layers 15 is composed of Cu.

The graph shown in FIG. 6 shows measured values when the second ferromagnetic sublayers 14c2 and the free magnetic layer 16 are composed of a Co₂MnGe alloy and the composition ratio of Ge in the Co₂MnGe alloy is 23 atomic percent. In the graph, the curved line formed by joining the squares shows an example in which each of the CoₓFe₁₀₀₋ₓ layers 21 adjacent to the corresponding second ferromagnetic sublayer 14c2 is composed of a Co₇₀Fe₃₀ layer and each of the CoₓFe₁₀₀₋ₓ layers 21 adjacent to the free magnetic layer 16 is composed of a Co₉₀Fe₁₀ layer. The curved line formed by joining the rhombuses shows a comparative example in which the CoₓFe₁₀₀₋ₓ layers 21 are not provided.

As shown in FIG. 6, when the thickness of each Cu layer is 50 Å or less, the values of Hᵢₙ in the example is lower than those in the comparative example, and thus there is a difference in the value of Hᵢₙ between the example and the comparative example. However, when the thickness of the Cu layer exceeds 50 Å, there is no difference in the value of Hᵢₙ between the example and the comparative example. According to this result, in the case where the composition ratio of Ge is 23 atomic percent and the nonmagnetic layers 15 are composed of Cu, when the thickness of each Cu layer exceeds 50 Å, the value of Hᵢₙ cannot be decreased despite the formation of the Co₇₀Fe₃₀ layers or the Co₉₀Fe₁₀ layers. Thus, the effect of forming the Co₇₀Fe₃₀ layers or the Co₉₀Fe₁₀ layers is not achieved.

FIG. 7 is a graph showing the relationship between the thickness of a Cu layer constituting each nonmagnetic layer 15 and a ferromagnetic coupling magnetic field Hᵢₙ generated by the magnetostatic coupling (topological coupling) between the free magnetic layer 16 and the corresponding pinned magnetic layer 14 when a dual spin-valve magnetic sensing element having the structure of the magnetic sensing element A2 shown in FIG. 2 is produced and each of the nonmagnetic layers 15 is composed of Cu.

The graph shown in FIG. 7 shows measured values when the second ferromagnetic sublayers 14c2 and the free magnetic layer 16 are composed of a Co₂MnGe alloy and the composition ratio of Ge in the Co₂MnGe alloy is 24 atomic percent. In the graph, the curved line formed by joining the squares shows an example in which each of the CoₓFe₁₀₀₋ₓ layers 21 adjacent to the corresponding second ferromagnetic sublayer 14c2 is composed of a Co₇₀Fe₃₀ layer and each of the CoₓFe₁₀₀₋ₓ layers 21 adjacent to the free magnetic layer 16 is composed of a Co₉₀Fe₁₀ layer. The curved line formed by joining the rhombuses shows a comparative example in which the CoₓFe₁₀₀₋ₓ layers 21 are not provided.

As shown in FIG. 7, when the thickness of each Cu layer is 60 Å or less, the values of Hᵢₙ in the example is lower than those in the comparative example, and thus there is a difference in the value of Hᵢₙ between the example and the comparative example. However, when the thickness of the Cu layer exceeds 60 Å, there is no difference in the value of Hᵢₙ between the example and the comparative example. According to this result, in the case where the composition ratio of Ge is 24 atomic percent and the nonmagnetic layers 15 are composed of Cu, when the thickness of each Cu layer exceeds 60 Å, the value of Hᵢₙ cannot be decreased despite the formation of the Co₇₀Fe₃₀ layers or the Co₉₀Fe₁₀ layers. Thus, the effect of forming the Co₇₀Fe₃₀ layers or the Co₉₀Fe₁₀ layers is decreased.

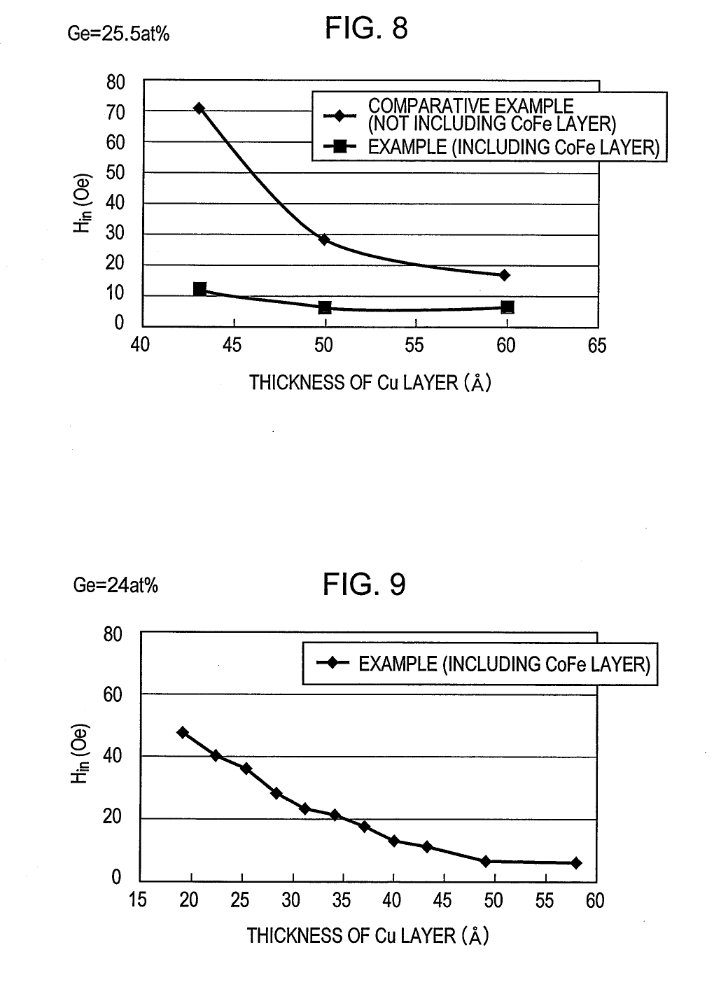

FIG. 8 is a graph showing the relationship between the thickness of a Cu layer constituting each nonmagnetic layer 15 and a ferromagnetic coupling magnetic field Hᵢₙ generated by the magnetostatic coupling (topological coupling) between the free magnetic layer 16 and the corresponding pinned magnetic layer 14 when a dual spin-valve magnetic sensing element having the structure of the magnetic sensing element A2 shown in FIG. 2 is produced and each of the nonmagnetic layers 15 is composed of Cu.

The graph shown in FIG. 8 shows measured values when the second ferromagnetic sublayers 14c2 and the free magnetic layer 16 are composed of a Co₂MnGe alloy and the composition ratio of Ge the Co₂MnGe alloy is 25.5 atomic percent. In the graph, the curved line formed by joining the squares shows an example in which each of the CoₓFe₁₀₀₋ₓ layers 21 adjacent to the corresponding second ferromagnetic sublayer 14c2 is composed of a Co₇₀Fe₃₀ layer and each of the CoₓFe₁₀₀₋ₓ layers 21 adjacent to the free magnetic layer 16 is composed of a Co₉₀Fe₁₀ layer. The curved line formed by joining the rhombuses shows a comparative example in which the CoₓFe₁₀₀₋ₓ layers 21 are not provided.

As shown in FIG. 8, when the thickness of each Cu layer is 60 Å or less, the values of Hᵢₙ in the example is lower than those in the comparative example, and thus there is a difference in the value of Hᵢₙ between the example and the comparative example. However, when the thickness of the Cu layer exceeds 60 Å, the difference in the value of Hᵢₙ between the example and the comparative example becomes small. According to this result, in the case where the composition ratio of Ge is 25.5 atomic percent and the nonmagnetic layers 15 are composed of Cu, when the thickness of each Cu layer exceeds 60 Å, the value of Hᵢₙ cannot be effectively decreased despite the formation of the Co₇₀Fe₃₀ layers or the Co₉₀Fe₁₀ layers. Thus, the effect of forming the Co₇₀Fe₃₀ layers or the Co₉₀Fe₁₀ layers is decreased.

FIG. 9 is a graph showing the relationship between the thickness of a Cu layer constituting each nonmagnetic layer 15 and a ferromagnetic coupling magnetic field Hᵢₙ generated by the magnetostatic coupling (topological coupling) between the free magnetic layer 16 and the corresponding pinned magnetic layer 14 when a dual spin-valve magnetic sensing element having the structure of the magnetic sensing element A2 shown in FIG. 2 is produced and each of the nonmagnetic layers 15 is composed of Cu.

The graph shown in FIG. 9 shows measured values when the second ferromagnetic sublayers 14c2 and the free magnetic layer 16 are composed of a Co₂MnGe alloy and the composition ratio of Ge in the Co₂MnGe alloy is 24 atomic percent. In the graph, the curved line formed by joining the rhombuses shows an example in which each of the CoₓFe₁₀₀₋ₓ layers 21 adjacent to the corresponding second ferromagnetic sublayer 14c2 is composed of a Co₇₀Fe₃₀ layer and each of the CoₓFe₁₀₀₋ₓ layers 21 adjacent to the free magnetic layer 16 is composed of a Co₉₀Fe₁₀ layer.

As shown in FIG. 9, when the thickness of each Cu layer is 18 Å, the value of Hᵢₙ is 50 (Oe), i.e., a value that does not cause a problem in practical use. Additionally, as shown in FIG. 9, when the thickness of the Cu layer is less than 18 Å, it is estimated that the value of Hᵢₙ is 50 (Oe) or more, which is undesirable in practical use.

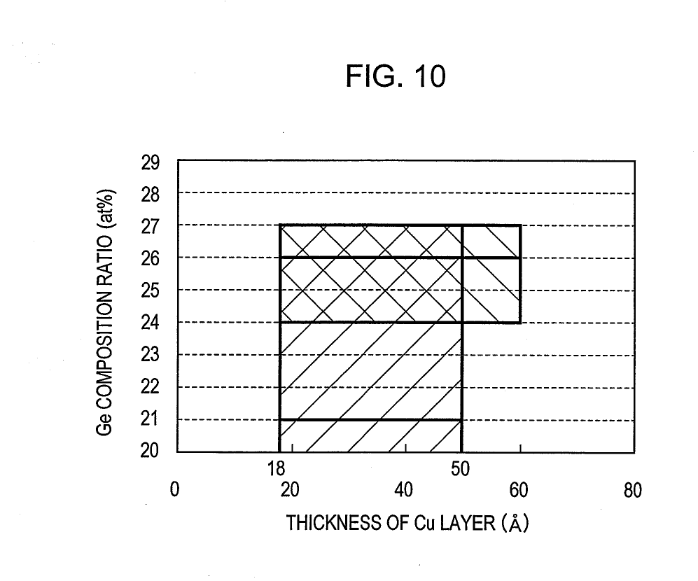

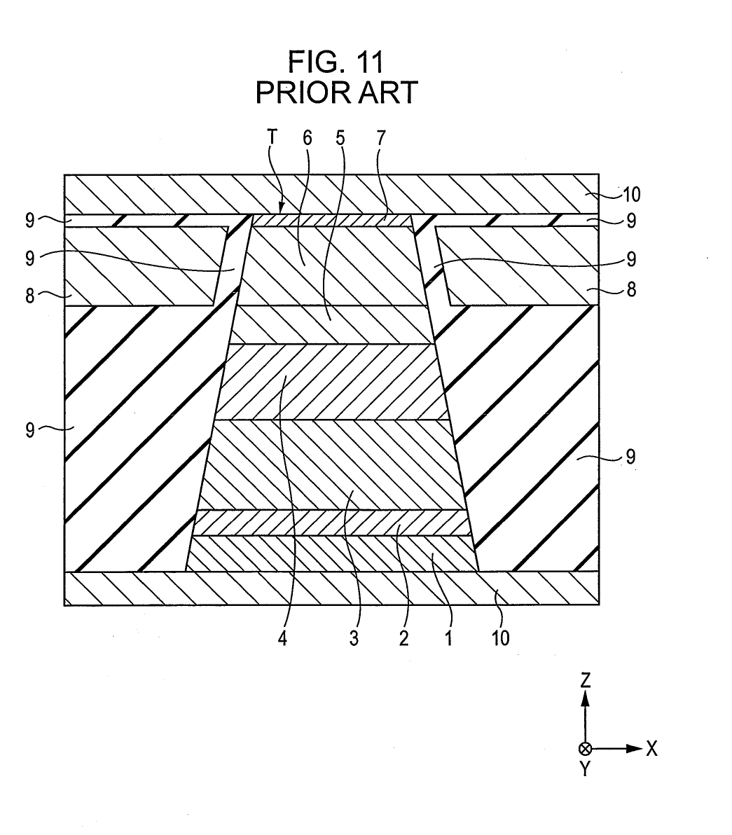

FIG. 10 is a graph showing results obtained by defining preferable ranges of the thickness of the Cu layer constituting the nonmagnetic layer 15 and the composition ratio of Ge in a Co₂MnGe alloy constituting the second ferromagnetic sublayers 14c2 and the free magnetic layer 16 on the basis of FIGS. 5 to 9. FIG. 10 shows two preferable ranges, i.e., a first preferable range and a second preferable range.

In FIG. 10, the first preferable range is the area shown by the oblique lines rising rightward, and the second preferable range is the area shown by the oblique lines rising leftward. In FIG. 10, the area where the oblique lines rising rightward and the oblique lines rising leftward intersect is an area where the first preferable range and the second preferable range overlap with each other.

The reason that the preferable ranges of the thickness of the Cu layer and the composition ratio of Ge are determined as shown in FIG. 10 will now be described.

First, referring to FIG. 4, when the composition ratio of Ge is in the range of 20 to 27 atomic percent, the value of ΔRA can be 7 (mΩμm²) or more. Therefore, as the first preferable range, a preferable composition ratio of Ge is determined to be in the range of 20 to 27 atomic percent.

On the other hand, referring to FIGS. 5 to 8, in any case of the composition ratio of Ge, when the thickness of the Cu layer is 50 Å or less, the effect of forming the Co₇₀Fe₃₀ layers or the Co₉₀Fe₁₀ layers can be achieved. Referring to FIGS. 5 and 6, at composition ratios of Ge of 22 atomic percent and 23 atomic percent, when each of the nonmagnetic layers 15 is composed of Cu and the thickness of the Cu layer exceeds 50 Å, the value of Hᵢₙ cannot be decreased despite the formation of the Co₇₀Fe₃₀ layers or the Co₉₀Fe₁₀ layers. Thus, the effect of forming the Co₇₀Fe₃₀ layers or the Co₉₀Fe₁₀ layers is not achieved. Therefore, a preferable thickness of the Cu layer is determined to be 50 Å or less.

Furthermore, referring to FIG. 9, when the thickness of the Cu layer is less than 18 Å, it is estimated that the value of Hᵢₙ is 50 (Oe) or more, which is undesirable in practical use. Therefore, the lower limit of the preferable thickness of the Cu layer is determined to be 18 Å.

In addition, referring to FIG. 4, when the composition ratio of Ge is in the range of 21 to 26 atomic percent, the value of ΔRA can be increased to 8 (mΩμm²) or more. Therefore, regarding the thickness of the Cu layer in the first range, a more preferable composition ratio of Ge is determined to be in the range of 21 to 26 atomic percent.

Next, referring to FIG. 4, when the composition ratio of Ge is in the range of 20 to 27 atomic percent, the value of ΔRA can be 7 (mΩμm²) or more. Therefore, as the second preferable range, a preferable composition ratio of Ge is in the range of 20 to 27 atomic percent.

On the other hand, referring to FIGS. 5, 6, and 7, in the case where the composition ratio of Ge is 24 atomic percent or less, when each of the nonmagnetic layers 15 is composed of Cu and the thickness of the Cu layer exceeds 60 Å, the value of Hᵢₙ cannot be decreased despite the formation of the Co₇₀Fe₃₀ layers or the Co₉₀Fe₁₀ layers. Thus, the effect of forming the Co₇₀Fe₃₀ layers or the Co₉₀Fe₁₀ layers is not achieved. However, referring to FIG. 8, at a composition ratio of Ge of 25.5 atomic percent, even when the thickness of the Cu layer is 60 Å or less, the value of Hᵢₙ in the example can be lower than that in the comparative example, and thus the effect of forming the Co₇₀Fe₃₀ layers or the Co₉₀Fe₁₀ layers can be achieved. Therefore, a preferable thickness of the Cu layer is determined to be in the range of 60 Å or less and a preferable composition ratio of Ge is determined to be in the range of 24 to 27 atomic percent.

Furthermore, referring to FIG. 9, when the thickness of the Cu layer is less than 18 Å, it is estimated that the value of Hᵢₙ is 50 (Oe) or more, which is undesirable in practical use. Therefore, the lower limit of the preferable thickness of the Cu layer is determined to be 18 Å.

Referring to FIG. 4, when the composition ratio of Ge is in the range of 21 to 26 atomic percent, the value of ΔRA can be increased to 8 (mΩμm²) or more. In addition, when the composition ratio of Ge is 24 atomic percent or more, the effect of forming the Co₇₀Fe₃₀ layers or the Co₉₀Fe₁₀ layers can be achieved. For these reasons, regarding the thickness of the Cu layer in the second range, a more preferable composition ratio of Ge is determined to be in the range of 24 to 26 atomic percent.

What is claimed is:

1. A magnetic sensing element comprising:
a multilayer film including a pinned magnetic layer in which the magnetization direction is pinned in one direction; a free magnetic layer; and a nonmagnetic layer provided between the pinned magnetic layer and the free magnetic layer,
wherein a current flows in a direction perpendicular to the surfaces of the layers in the multilayer film,
at least one of the pinned magnetic layer and the free magnetic layer comprises a half-metallic alloy layer, and
a CoₓFe₁₀₀₋ₓ layer (wherein X represents a composition ratio and satisfies 0≦X≦100) is provided between the half-metallic alloy layer and the nonmagnetic layer.

2. The magnetic sensing element according to claim 1, wherein the half-metallic alloy layer comprises a Heusler alloy represented by a composition ratio of X₂YZ where X is an element selected from Group IIIA to Group IIB in the periodic table, Y is Mn, and Z is at least one element selected from Al, Si, Ga, Ge, In, Sn, Tl, Pb, and Sb or a Heusler alloy represented by a composition ratio of XYZ where X is an element selected from Group IIIA to Group IIB in the periodic table, Y is Mn, and Z is at least one element selected from Al, Si, Ga, Ge, In, Sn, Tl, Pb, and Sb.

3. The magnetic sensing element according to claim 1, wherein the nonmagnetic layer comprises at least one element selected from Cu, Au, and Ag.

4. The magnetic sensing element according to claim 1, wherein the half-metallic alloy layer comprises a Co₂MnGe alloy, the nonmagnetic layer comprises Cu, the thickness of the Cu layer constituting the nonmagnetic layer is in the range of 18 to 50 Å, and the composition ratio of Ge in the Co₂MnGe alloy constituting the half-metallic alloy layer is in the range of 20 to 27 atomic percent.

5. The magnetic sensing element according to claim 4, wherein the composition ratio of Ge in the Co₂MnGe alloy constituting the half-metallic alloy layer is in the range of 21 to 26 atomic percent.

6. The magnetic sensing element according to claim 1, wherein the half-metallic alloy layer comprises a Co₂MnGe alloy, the nonmagnetic layer comprises Cu, the thickness of the Cu layer constituting the nonmagnetic layer is in the range of 18 to 60 Å, and the composition ratio of Ge in the Co₂MnGe alloy constituting the half-metallic alloy layer is in the range of 24 to 27 atomic percent.

7. The magnetic sensing element according to claim 6, wherein the composition ratio of Ge in the Co₂MnGe alloy constituting the half-metallic alloy layer is in the range of 24 to 26 atomic percent.

8. The magnetic sensing element according to claim 1, wherein the pinned magnetic layer is provided above the free magnetic layer.

9. The magnetic sensing element according to claim 1, wherein the pinned magnetic layer is provided below the free magnetic layer.

10. The magnetic sensing element according to claim 1, wherein the nonmagnetic layer and the pinned magnetic layer are provided below the free magnetic layer and another nonmagnetic layer and another pinned magnetic layer are provided above the free magnetic layer.
